(19) United States
(12) Patent Application Publication
(10) Pub. No.: US 2012/0201104 A1
(43) Pub. Date: Aug. 9, 2012

(54) WRIST BELT OR BRACELET HAVING A TIMEPIECE FUNCTION

(76) Inventor: Massimo AMENDUNI GRESELE, Vicenza (IT)

(21) Appl. No.: 13/359,799

(22) Filed: Jan. 27, 2012

(30) Foreign Application Priority Data
Feb. 8, 2011 (EP) 11153653.8

(51) Int. Cl. G04G 9/00

(52) U.S. Cl. 368/239

(57) ABSTRACT

A wrist belt or bracelet having a timepiece function, comprises an annular plastic material body within which a flexible material strip which carries display means, an electronic control unit and an electrical power supply battery, is embedded. The display means and the electronic control unit are provided for displaying the time through numbers or symbols which are lighted along the abovementioned strip.

The present invention regards a wrist belt or bracelet having a timepiece function.

The object of the invention is to provide a wrist belt or bracelet of the type indicated above having a simple structure, that is easy to use and that is suitable to be provided in several configurations.

With the aim of attaining such object, the invention consists in a wrist belt or bracelet characterised in that it comprises:

a body of annular shape, or in form of a portion of a ring, formed by a substantially flat strip, made of plastic, and at least partially transparent, material,

an inner strip made of flexible material, embedded within the body of plastic material,

electrical display means, carried by said inner strip, on the surface thereof facing outwardly,

a flat-shaped electronic control unit, carried by said inner strip and electrically connected to said display means through electrical connections carried by said inner strip,

an electrical power supply battery, carried by said inner strip and electrically connected to said control unit,

said display means and said control unit being provided for displaying the time through selective lighting of numbers or symbols which are lighted along said inner strip.

In a preferred embodiment, said inner strip comprises a plurality of areas circumferentially spaced along the strip and each associated to a number or symbol of a time to be displayed, so that the number or symbol of the displayed time travels along the strip with the time.

Preferably, sub-areas (8) or numbers or symbols for the display of the fractions of an hour are provided for at each area of said inner strip associated to the display of a given time.

In an embodiment of the invention, the abovementioned inner strip made of flexible material is made of a fabric comprising portions of electroluminescent material, which constitute the abovementioned display means.

Still in a preferred embodiment, the abovementioned plastic material body is elastically deformable and includes a bellow-like portion, elastically extensible in circumferential direction, starting from a rest condition, for enabling to adapt the belt or bracelet to various wrist dimensions. The inner strip does not extend into the area of the body of the belt or bracelet where said extensible section is provided.

Obviously, the general configuration of the belt or bracelet according to the invention may vary with reference to the shape of the belt, with reference to the symbols used for indicating the time and with reference to the way the hours and the fractions of an hour are displayed. Furthermore, the belt can also be provided with a buckle or any other fastening device.

### BRIEF DESCRIPTION OF THE DRAWINGS

Further characteristics and advantages of the invention shall be apparent from the description that follows with reference to the attached drawings, provided purely by way of non-limiting example, wherein:

FIG. 1 is a perspective view of an embodiment of a wrist belt having a timepiece function according to the invention, and

FIG. 2 is an exploded perspective view of the belt of FIG. 1.

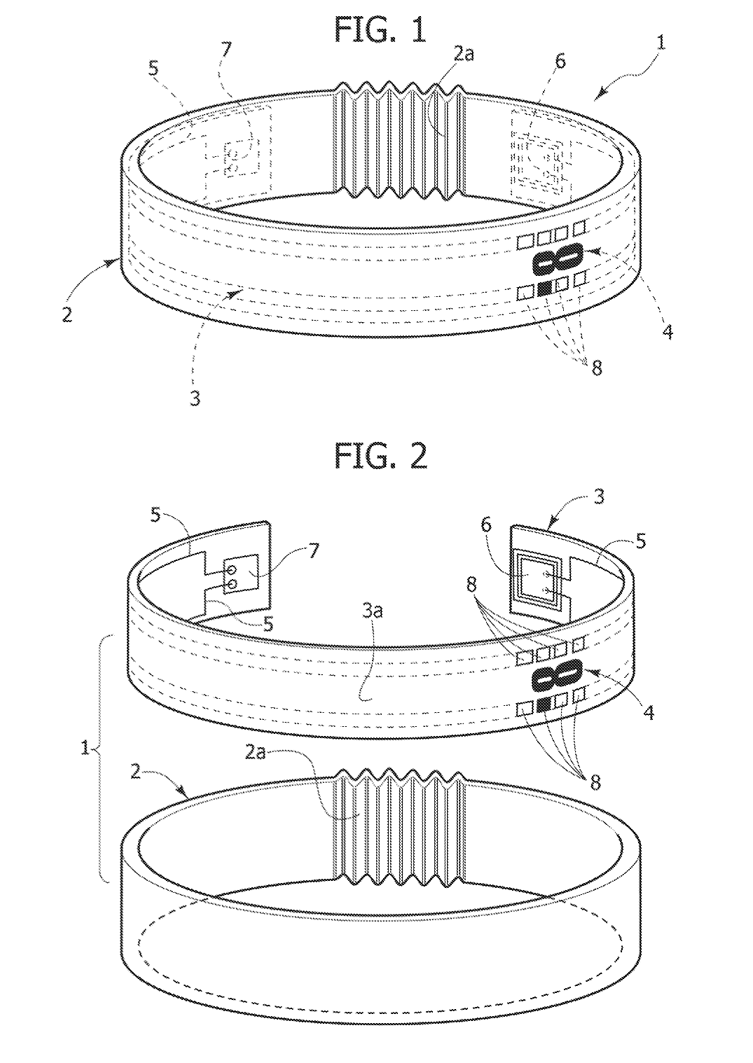

### DETAILED DESCRIPTION OF THE INVENTION

With reference to the drawings, a wrist belt or bracelet having a timepiece function, comprising a body 2 made of relatively elastically deformable plastic material in form of a substantially flat strip, is indicated in its entirety with number 1.

Still in the case of the illustrated example, the body 2 has a body constituting a complete ring, but the body 2 can be provided in form of a portion of a ring. Both in the case of a body 2 in form of complete ring and in the case of a body 2 in form of a portion of a ring, it can also be provided for that such body remains firmly in position once worn on the wrist due to the elastic return thereof or the body 2 can alternatively be provided with any type of buckle or fastening device.

Still in the specific case of the illustrated example, the body 2 is in form of complete ring and it includes a bellow-like portion 2a, elastically extensible in the circumferential direction of the ring starting from the rest position illustrated in the example.

The plastic material body 2 is at least partly transparent so as to let the surface 3a, facing outwards, of an inner strip 3, made of flexible material, which is embedded within the annular body 2, to be visible.

In the case of the illustrated example, the strip 3 has a circumferential extension smaller than the entire circumferential extension of the body 2, so that the strip 3 is interrupted at the area occupied by the bellow-like section 2a.

In the preferred embodiment, the strip 3 is embedded within the plastic material body 2 when moulding the latter. However, a plastic material body 2 can be provided having a seat prearranged for mounting the flexible strip 3 therein and having an element for covering such seat.

The flexible strip 3 carries, on the outer surface 3a thereof, electrical display means 4 which are connected through electrical conductors 5 integrated in the strip 3 to a flat-shaped electronic control unit 6, also carried by the strip 3 and to a power supply battery 7, also carried by the strip.

The details regarding the electronic control unit and the power supply battery are not illustrated herein, given that such components can be obtained in any manner.

In the case of the preferred embodiment, the strip 3 is made of a fabric comprising electroluminescent portions constituting the display means which selectively display the time in a plurality of successive areas of the surface 3a, circumferentially spaced along such surface. The figures of the attached drawings show the situation in which number 8 is lighted at an area of the strip 3a which is associated to the display of 8 o'clock. Over time, the subsequent time is displayed at different areas, distributed along the circumferential extension of the strip 3a, so that the user can see the symbol which indicates the time “moving” along the belt or bracelet.

Still in the case of the specific embodiment illustrated herein, sub-areas (or numbers or symbols), which light progressively, to indicate the fractions of an hour are associated to each area corresponding to the display of a specific time. For example six, or eight, or ten sub-areas 8 are provided for each area of the belt corresponding to a given time.

Obviously, the embodiment illustrated herein is provided purely by way of example. In particular, the display means could be provided according to any other per se known technique, for example in form of LED-chips mounted directly on conductive tracks borne on the flexible material strip 3.

Furthermore, it is clear that the specific configuration of the body 2 of the wrist belt or bracelet can also be entirely different from the one illustrated herein purely by way of example, without departing from the scope of protection of the attached claims.

1. Wrist belt or bracelet having a timepiece function, characterised in that it comprises:
a body of annular shape or in form of a portion of a ring, formed by a substantially flat strip, made of a plastic, and at least partially transparent, material,
an inner strip made of a flexible material, embedded within the body of plastic material,
electrical display means carried by said inner strip, on the surface thereof facing outwardly,
a flat-shaped electronic control unit, carried by said inner strip and connected to said display means through electrical connections carried by said inner strip,
an electrical power supply battery, carried by said inner strip and electrically connected to said control unit,
said display means and said control unit being provided for displaying the time through numbers or symbols which are lighted along said strip.

2. Wrist belt or bracelet according to claim 1, wherein said inner strip comprises a plurality of areas circumferentially spaced along the strip and each associated to the number or symbol of a time to be displayed, so that the number or symbol of the displayed time moves along the strip with the time.

3. Wrist belt or bracelet according to claim 2, wherein several sub-areas or numbers or symbols for the display of the fractions of an hour are provided for at each area of said inner strip associated to the display of a given hour.

4. Wrist belt or bracelet according to claim 1, wherein the abovementioned inner strip made of flexible material is made of a fabric comprising portions of electroluminescent material, which constitute the abovementioned display means.

5. Wrist belt or bracelet according to claim 1, wherein said plastic material body includes a section elastically extensible in circumferential direction, starting from a rest condition, said section being provided in an area into which said inner strip does not extend.
